(19) United States
(12) Patent Application Publication
(10) Pub. No.: US 2012/0033677 A1
(43) Pub. Date: Feb. 9, 2012

(54) ROUTER AND METHOD FOR CONFIGURING MULTIPLE INTERNET PROTOCOL ADDRESSES

(75) Inventor: JIA-XUAN HUANG, Tu-Cheng (TW)

(73) Assignee: HON HAI PRECISION INDUSTRY CO., LTD., Tu-Cheng (TW)

(21) Appl. No.: 12/880,163

(22) Filed: Sep. 13, 2010

(30) Foreign Application Priority Data
Aug. 3, 2010 (CN) 201010243715.1

(51) Int. Cl. H04L 12/56; G06F 15/177

(52) U.S. Cl. 370/401; 709/220

(57) ABSTRACT

A router and method for configuring multiple Internet Protocol addresses includes setting at least two IP addresses for a local user terminal, and mapping the IP addresses to a domain name of a remote user terminal. A router advertisement packet that includes the IP addresses is generated and transmitted to the local user terminal to configure the IP addresses for the local user terminal. The IP addresses are determined to be configured for the local user terminal successfully if the router receives a router solicitation packet from the local user terminal.

### BACKGROUND

1. Technical Field

Embodiments of the present disclosure relate to Internet Protocol (IP) address management, and more particularly to a router and a method for configuring multiple IP addresses using the router.

2. Description of Related Art

Network congestion may occur when a link or a node is carrying too much data. For example, a local user terminal (e.g., a computer) may be disconnected to a remote terminal if network congestion occurs. Generally, once disconnected, a local user terminal needs to get a new IP address to establish a new communication connection with the remote user terminal. However, it can be inefficient and time-consuming to establish such a new communication connection.

### BRIEF DESCRIPTION OF THE DRAWINGS

FIG. 1 is a schematic diagram of one embodiment of a router in communication with a local user terminal.

FIG. 2 is a block diagram of one embodiment of the router.

FIG. 3 is a schematic diagram of one embodiment of a program segment of a router advertisement packet generated by the router of FIG. 2.

FIG. 4 is a flowchart of one embodiment of a method for configuring multiple Internet Protocol addresses using the router of FIG. 2.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, Java, C, or Assembly, for example. One or more software instructions in the modules may be embedded in firmware, such as an erasable programmable read only memory (EPROM). It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system.

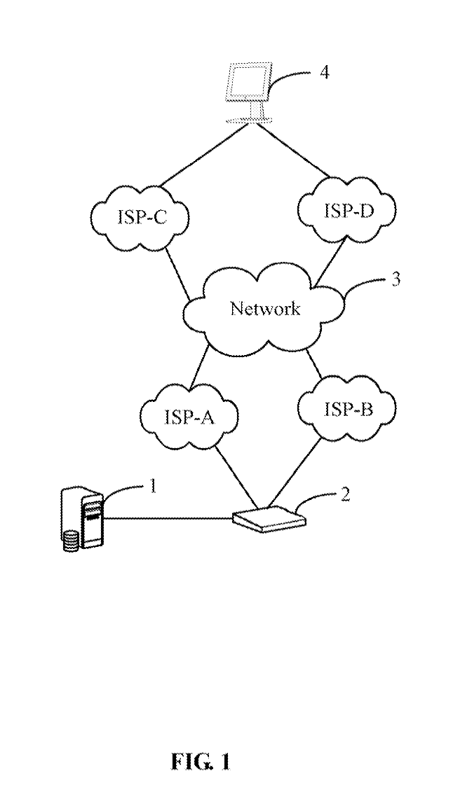

FIG. 1 is a schematic diagram of one embodiment of a router 2 in communication with a local user terminal 1. The local user terminal 1 is connected to a remote user terminal 4 through the router 2 and a network 3. The router 2 may be used to configure multiple Internet Protocol (IP) addresses for the local user terminal 1, to allow the local user terminal 1 to use the multihoming technique. In some embodiments, the multihoming technique is used to increase the reliability of an Internet connection for an IP network. By using the multihoming technique, the reliability of an Internet connection between the local user terminal 1 and the remote user terminal 4 may be enhanced.

In some embodiments, the local user terminal 1 and the remote user terminal 4 may be computers, communication devices, notebook computers, or personal digital assistants, for example.

The network 3 may be an Intranet, the Internet, an Ethernet, or any other kind of communication network. In some embodiments, the network 3 may be provided by different Internet Service Providers (ISPs), such as ISP-A, ISP-B, ISP-C, and ISP-D. For example, the router 2 may connect the local user terminal 1 to the remote user terminal 4 through a first communication path consisting of ISP-A and ISP-C, or a second communication path consisting of ISP-B and ISP-D.

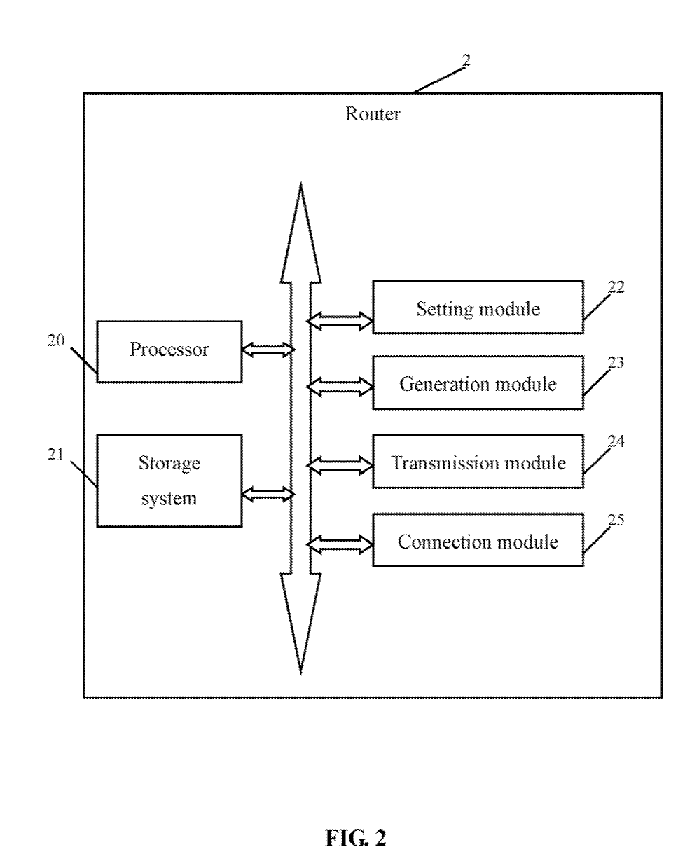

FIG. 2 is a block diagram of one embodiment of the router 2. The router 2 includes a processor 20 and a storage system 21. The processor 20 executes one or more computerized operations of the router 2 and other applications, to provide functions of the router 2. The storage system 21 stores one or more programs, such as programs of the operating system, other applications of the router 2, and various kinds of data, such as preset parameters. In some embodiments, the storage system 21 may include a memory of the router 2 and/or an external storage card, such as a memory stick, a smart media card, a compact flash card, or any other type of memory card.

In some embodiments, the router 2 further includes a setting module 22, a generation module 23, a transmission module 24, and a connection module 25. The modules 22-25 may include computerized codes in the form of one or more programs that are stored in the storage system 21. The computerized codes include instructions that are executed by the at least one processor 20 to provide functions for modules 22-25. Details of these functions will be provided below.

The setting module 22 sets at least two IP addresses for the local user terminal 1, and stores the at least two IP addresses in the storage system 21. In some embodiments, the IP addresses may be IP version 4 (IPv4) addresses or IP version 6 (IPv6) addresses. IPv4 is the fourth revision in the development of the IP and is a current standard of the IP. Ipv6 is a next-generation IP version and is designed to succeed IPv4. IPv6 provides a vastly larger address space than IPv4.

The setting module 22 further maps the IP addresses to a domain name of the remote user terminal 4. In some embodiments, the setting module 22 may map the IP addresses to the domain name of the remote user terminal 4 using a mapping table. The mapping table records relations between each IP address and a target address, such as the domain name of the remote user terminal 4. On the World-Wide Web, the domain name is a part of the Uniform Resource Locator (URL), for example, the domain name is “www.abc123.com”.

In some embodiments, the local terminal 1 may be connected to the remote terminal 4 through multiple communication paths provided by one or more ISPs. Once a current communication path is disconnected, another communication path is activated to connect the local terminal 1 and the remote user terminal 4. Thus, the local user terminal 1 does not need to request a new IP address if the current communication path is disconnected, and then establishes a new connection with the remote user terminal 4 using the new IP address.

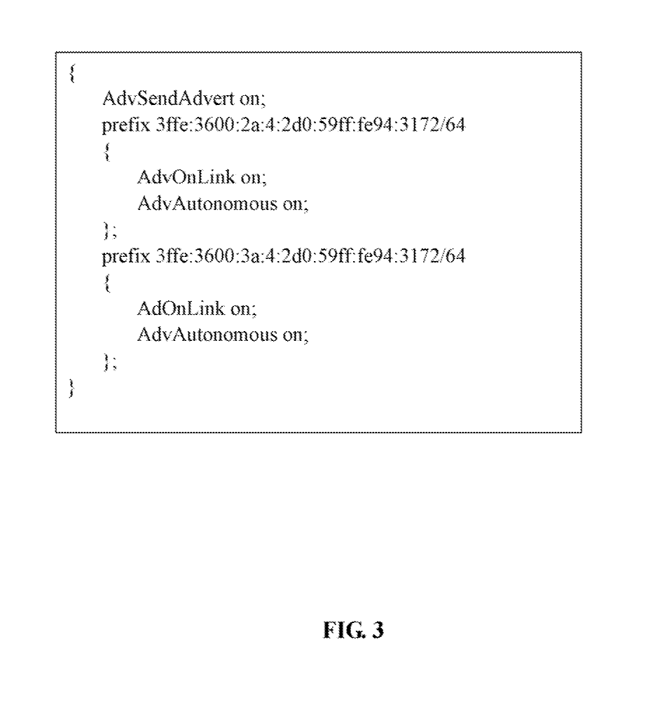

The generation module 23 generates a router advertisement (RA) packet to include the IP addresses set by the setting module 22. As a program segment of the RA packet shown in FIG. 3, there are two IP addresses, such as “3ffe:3600:2a:4:2d0:59ff:fe94:3172/64” and “3ffe:3600:3a:4:2d0:59ff:fe94:3172/64,” for example.

The transmission module 24 transmits the RA packet to the local user terminal 1 to configure the IP addresses for the local user terminal 1. If the local user terminal 1 receives the RA packet, the local user terminal 1 may store the IP addresses in a memory of the local user terminal 1, and sends a router solicitation (RS) packet to the router 2.

In response to receiving the RS packet from the local user terminal 1, the transmission module 24 determines that the addresses are configured for the local user terminal 1 successfully. In some embodiments, if the transmission module 24 does not receive an RS packet from the local user terminal 1 during a predetermined time (e.g., 10 s), the transmission module 24 may repeatedly send the RA packet to the local user terminal 1 again until the transmission module 24 receives the RS packet.

The connection module 25 is configured to establish a first connection between the local user terminal 1 and the remote user terminal 4 using a first IP address of the IP addresses set by the setting module 22.

The connection module 25 is also configured to detect if the first connection between the local user terminal 1 and the remote user terminal 4 using the first IP address is disconnected. If the first connection is disconnected, the connection module 25 further establishes a second connection between the local user terminal 1 and the remote user terminal 4 using a second IP address of the IP addresses.

By utilizing the modules 22-25, the network stability of connections between the local user terminal 1 and the remote user terminal 4 may be ensured.

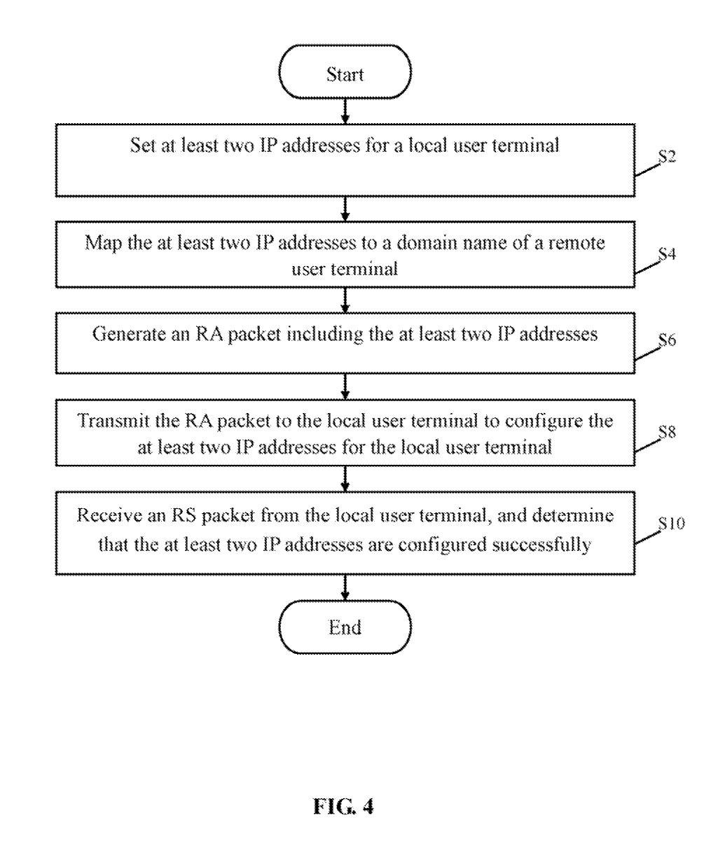

FIG. 4 is a flowchart of one embodiment of a method for configuring multiple IP addresses using the router 2 of FIG. 2. Depending on the embodiment, additional blocks may be added, others removed, and the ordering of the blocks may be replaced.

In block S2, the setting module 22 sets at least two IP addresses for the local user terminal 1, and stores the at least two IP addresses in the storage system 21. As mentioned above, the IP addresses may be IPv4 addresses or IPv6 addresses.

In block S4, the setting module 22 further maps the IP addresses to a domain name of the remote user terminal 4.

In block S6, the generation module 23 generates a router advertisement (RA) packet to include the IP addresses set by the setting module 22.

In block S8, the transmission module 24 transmits the RA packet to the local user terminal 1 to configure the IP addresses for the local user terminal 1. If the local user terminal 1 receives the RA packet, the local user terminal 1 may store the IP addresses in a memory of the local user terminal 1, and sends a router solicitation (RS) packet to the router 2.

In response to receiving the RS packet from the local user terminal 1, in block S10, the transmission module 24 determines that the addresses are configured for the local user terminal 1 successfully.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for configuring multiple Internet Protocol (IP) addresses using a router, the router in communication with a local user terminal, the method comprising:
setting at least two IP addresses for the local user terminal;
mapping the at least two IP addresses to a domain name of a remote user terminal;
generating a router advertisement (RA) packet that comprises the at least two IP addresses;
transmitting the RA packet to the local user terminal to configure the at least two IP addresses for the local user terminal; and
in response to receiving a router solicitation (RS) packet from the local user terminal, determining that the at least two IP addresses are configured for the local user terminal successfully.

2. The method according to claim 1, further comprising:
establishing a first connection between the local user terminal and the remote user terminal using a first IP address of the at least two IP addresses.

3. The method according to claim 2, further comprising:
establishing a second connection between the local user terminal and the remote user terminal using a second IP address of the at least two IP addresses, under the condition that the first connection is disconnected.

4. The method according to claim 1, wherein the at least two IP addresses are IPv4 addresses or IPv6 addresses.

5. The method according to claim 1, wherein the at least two IP addresses are mapped to the domain name of the remote user terminal using a mapping table.

6. The method according to claim 1, further comprising:
storing the at least two IP addresses in a storage system of the router.

7. A router, the router in communication with a local user terminal, the router comprising:
a storage system;
at least one processor; and
one or more programs stored in the storage system and being executable by the at least one processor, the one or more programs comprising:
a setting module operable to set at least two IP addresses for the local user terminal, and map the at least two IP addresses to a domain name of a remote user terminal;
a generation module operable to generate a router advertisement (RA) packet that comprises the at least two IP addresses; and
a transmission module operable to transmit the RA packet to the local user terminal to configure the at least two IP addresses for the local user terminal, and determine that the at least two IP addresses are configured for the local user terminal successfully in response to receiving a router solicitation (RS) packet from the local user terminal.

8. The router according to claim 7, wherein the one or more programs further comprise a connection module operable to establish a first connection between the local user terminal and the remote user terminal using a first IP address of the at least two IP addresses.

9. The router according to claim 8, wherein the connection module is further operable to establish a second connection between the local user terminal and the remote user terminal using a second IP address of the at least two IP addresses, under the condition that the first connection is disconnected.

10. The router according to claim 7, wherein the at least two IP addresses are IPv4 addresses or IPv6 addresses.

11. The router according to claim 7, wherein the setting module maps the at least two IP addresses to the domain name of the remote user terminal using a mapping table.

12. The router according to claim 7, wherein the setting module is further operable to store the at least two IP addresses in the storage system of the router.

13. A storage medium storing a set of instructions, the set of instructions capable of being executed by a processor to perform a method for configuring multiple Internet Protocol (IP) addresses using a router, the router in communication with a local user terminal, the method comprising:
setting at least two IP addresses for the local user terminal;
mapping the at least two IP addresses to a domain name of a remote user terminal;
generating a router advertisement (RA) packet that comprises the at least two IP addresses;
transmitting the RA packet to the local user terminal to configure the at least two IP addresses for the local user terminal; and
in response to receiving a router solicitation (RS) packet from the local user terminal, determining that the at least two IP addresses are configured for the local user terminal successfully.

14. The storage medium as claimed in claim 13, wherein the method further comprises:
establishing a first connection between the local user terminal and the remote user terminal using a first IP address of the at least two IP addresses.

15. The storage medium as claimed in claim 14, wherein the method further comprises:
establishing a second connection between the local user terminal and the remote user terminal using a second IP address of the at least two IP addresses, under the condition that the first connection is disconnected.

16. The storage medium as claimed in claim 13, wherein the at least two IP addresses are IPv4 addresses or IPv6 addresses.

17. The storage medium as claimed in claim 13, wherein the at least two IP addresses are mapped to the domain name of the remote user terminal using a mapping table.

18. The storage medium as claimed in claim 13, wherein the method further comprises:
storing the at least two IP addresses in a storage system of the router.
